(19) United States
(12) Patent Application Publication
(10) Pub. No.: US 2025/0110800 A1
(43) Pub. Date: Apr. 3, 2025

(54) ON-DEMAND CODE EXECUTION COMPUTING RESOURCE MANAGEMENT

(71) Applicant: Amazon Technologies, Inc., Seattle, WA (US)

(72) Inventors: Hari Ohm Prasath Rajagopal, Tracy, CA (US); Shivendra Panicker, Seattle, WA (US); Prashant Kumar Singh, Seattle, WA (US); Amit Gupta, Bellevue, WA (US)

(21) Appl. No.: 18/478,476

(22) Filed: Sep. 29, 2023

(51) Int. Cl. G06F 9/50

(52) U.S. Cl. CPC G06F 9/5077; G06F 9/5055

(57) ABSTRACT

Systems and methods are provided for an on-demand code execution service comprising a set of computing devices for on-demand execution of function code while continuing to facilitate executing long-running background processes. A subset of resources may be initialized based, at least in part, on the application configuration data including at least a request-response process, a background process, and a lesser set of computing resources for the background process. After the execution of the background process has begun, a first request may be received. The on-demand code execution service may increase computing resources to a larger set of computing resources to generate a first response to the first request. The first response may then be provided to an external set of computing resources. After determining that the queue contains no additional requests, the on-demand code execution service may decrease the level of computing resources to the lesser set of computing resources.

### BACKGROUND

Computing systems can utilize communication networks to exchange data. In some implementations, a computing system can receive, and process data provided by another computing system. For example, a computing system receive data entered using another computing system, store the data, process the data, and so on.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure. To easily identify the discussion of any specific element or act, the most significant digit(s) in a reference number typically refers to the figure number in which that element is first introduced.

FIG. 1 is a block diagram of an illustrative computing environment in which environment in which an on-demand code execution system can operate in conjunction with a data storage system according to some embodiments.

FIG. 2 is a block diagram of an illustrative computing system configured to provide data management across function invocations in the on-demand code execution system according to some embodiments.

FIG. 3 illustrates an example routine for a request/response cycle executed on a virtual execution environment (e.g., a virtual machine instance, a container, etc.) by an on-demand code execution system.

FIG. 4 illustrates a diagram depicting interactions between a client device and components of an on-demand code execution system during execution of a first request.

FIG. 5A illustrates a set of example interactions between components where a queue 502 is used to handle multiple requests received from client devices.

FIG. 5B illustrates another set of example interactions between components where a queue 502 is used to handle multiple requests received from client devices 402.

### DETAILED DESCRIPTION

The present disclosure relates to managing application instances with code executing in an on-demand (“serverless”) manner, including code that executes synchronously (e.g., according to a request-response model), and additional code that executes continuously or asynchronously (e.g., as a background process outside of the request-response model). To provide computing resources for the continuous or asynchronous components of such application instances even when there is no synchronous process executing, a baseline quantity or set of computing resources can be provisioned (e.g., a quantity or set of computing resources that is smaller than what is provisioned for the synchronous process). When a synchronous process is to be executed, the quantity or set of computing resources provisioned for the application can be increased to provide a desired degree of performance in execution of the synchronous process. In this way, application developers can gain the benefits of an on-demand or “serverless” platform while ensuring that longer-running background process or other asynchronous tasks can also execute on the same platform.

### INTRODUCTION

Some data centers may include a number of interconnected computing systems to provide computing resources to users of the data center. To facilitate increased utilization of data center resources, virtualization technologies allow a single physical computing device to host one or more instances of virtual execution environments that appear and operate as independent computing devices to users of a data center. With virtualization, the single physical computing device can create, maintain, delete, or otherwise manage virtual execution environments such as virtual machines (VMs), microVMs, containers, or other virtual computing components in a dynamic manner. In turn, users can request computer resources from a data center, including single computing devices or a configuration of networked computing devices, and be provided with varying numbers of virtual resources.

In addition to computational resources, data centers provide a number of other beneficial services to client devices. For example, data centers may provide data storage services configured to store data submitted by client devices and enable retrieval of that data over a network. A variety of types of data storage services can be provided, often varying according to their input/output (I/O) mechanisms. Some data centers include an on-demand code execution system, sometimes referred to as a serverless function execution system.

Generally described, on-demand code execution systems enable execution of arbitrary user-designated function or application code, without requiring the user to create, maintain, or configure an execution environment (e.g., a physical or virtual machine) in which the function or application code is executed. For example, whereas conventional computing services often require a user to provision a specific device (virtual or physical), install an operating system on the device, configure application settings, define network interfaces, and so on, an on-demand code execution system may enable a user to submit code and may provide to the user an application programming interface (API) that, when used, enables the user to request execution of the code. Upon receiving a call through the API, the on-demand code execution system may dynamically generate an execution environment for the code, provision the environment with the code, execute the code, and provide a result. Thus, an on-demand code execution system can remove a need for a user to handle configuration and management of environments for code execution. Due to the flexibility of on-demand code execution system to execute arbitrary function or application code, such a system can be used to create a variety of network services. For example, such a system could be used to create a “micro-service,” a network service that implements a small number of functions (or only one function), and that interacts with other services to provide an application. As another example, such a system could be used to implement a software-as-a-service (SaaS) platform that provides customers with the ability to deploy entire applications in an on-demand serverless manner (instead of—or in addition to—individual functions).

In the context of on-demand code execution systems, the instance of function or application code executing to provide such a service is often referred to as “invoked code,” or more specifically as an “invoked function” or an “invoked application,” or simply as “code,” a “function,” or an “application,” respectively, for brevity. The terms “application,” “application code,” and “application software” are used herein in accordance with their usual and customary meaning in the field of computer technology, and refer to a computer program (or set of computer programs) designed to carry out a specific task (or set of tasks) other than those relating solely to the operation of a computing system itself. “Functions,” “function code,” or “function software” may define a “task,” and implement specific functionality corresponding to that task when executed on a virtual machine instance of the on-demand code execution system. Applications may include functions or may call external functions. Applications are typically executed by or at the instruction of end users but are not necessarily interactive. For example, an application may be scheduled to execute or be triggered to execute in response to an event and may perform various processing tasks before terminating without any end user interaction.

The infrastructure or configuration of an on-demand code execution system may place certain limitations on running functions or applications. In some cases, these limitations can interfere with or prevent use of the on-demand code execution system to execute long-running processes (e.g., background processes, asynchronous processes) in addition to executing function or application code according to a request-response model or other synchronous execution model. For example, it may be desirable to run a background process requiring a small amount of computing resources for a relatively long period of time (compared to execution according to a request-response model), while also being able to scale additional computing resources as required for other operations (e.g., processing requests in a synchronous manner). However, conventional on-demand code execution systems allocate resources only to meet the requirements of an invoked function according to a request-response model or other synchronous execution model. Users requiring a longer-running process in addition to this are required to create, maintain, or configure a separate execution environment for that process, which, for those users, significantly reduces the deployment and management benefits of using an on-demand code execution system. To avoid deploying an application or system across different environments and platforms, users may opt to create, configure, and maintain a single execution environment outside of the on-demand code execution service, which altogether eliminates the cost, deployment, and management benefits of using an on-demand code execution.

Some aspects of the present disclosure address some or all of the issues noted above, among others, with an on-demand code execution system that provisions computing resources to applications in a configurable and dynamic manner, depending upon the processing model of individual application components. In some embodiments, the configurable and dynamic provisioning of computing resources to an application provides a desired degree of performance to request-response or other synchronous operations, while also allowing a background or asynchronous process to run for a longer period of time (e.g., outside of the request-response model) in a resource-efficient and cost-effective manner. For example, the application can be provisioned with a “baseline” non-zero level of computing capacity sufficient to maintain operation of the background process, and the system can dynamically increase computing resources as needed to the meet the performance requirements of synchronous processes that are invoked. In some embodiments, this baseline amount of resources may be configurable to achieve a minimum non-zero level of computing resources. Dynamic resource provisioning to maintain at least the baseline, non-zero level of computing capacity can save time and computing resources for users requiring a long-running background process without affecting (or without substantially affecting) the performance of the application as a whole. Moreover, such configurable dynamic resource provisioning can allow applications previously developed for customer-managed environments (e.g., traditional server-based deployments) to be deployed to an on-demand code execution environment without any changes (or without any significant changes) in the architecture of the applications. For example, rather than requiring a redesign of an application into two separate applications that run in two separate environments (e.g., a request-response component that runs in an on-demand code execution system and a continuously-running background component running on a traditional server-based deployment), the application in its entirety can be deployed on the on-demand code execution system with resources that dynamically scale up and down in a cost-effective manner, but which do not scale below a configurable minimum quantity of resources to be maintained for the background component.

In some embodiments, the on-demand code execution system may receive application configuration data, such as configuration data relating to a baseline non-zero level of computing capacity required to run the background process. For example, the instructions relating to the computing resources may include an indication of processing resources or network bandwidth required to run the background process. Configuration data may also include code and data necessary to run the background process and a request/response process.

As used herein, the “baseline non-zero level of computing capacity” may also be referred to as a “configurable lesser level” of computing capacity or computing resources (or simply as a “lesser level” for brevity) to distinguish it from the level of computing capacity or computing resources required or desired for execution of other parts of an application, such as a synchronous process. The level of computing capacity or computing resources required or desired for other parts of the application may be referred to as a “higher level of computing capacity.” The term “computing capacity” may refer to—or be interchangeable with—a “set of computing resources.” For example, a baseline or lesser non-zero level of computing capacity may be a baseline or smaller set of computing resources. As another example, a higher level of computing capacity may be a larger set of computing resources.

In some embodiments, the configuration data may further include instructions relating to a higher level of computing capacity to run one or more invoked functions. For example, the configuration data relating to the maximum level of computing capacity may include instructions to increase computing resources to the higher-level of computing capacity when an application or function is invoked (e.g., to process a request). In some embodiments, the configuration data relating to the higher level of computing capacity may include instructions to scale resources within a range defined by the lesser non-zero level of computing capacity and the higher level of computing capacity to the amount of computing resources necessary to run an invoked application or function. For example, an invoked function may require more than the lesser non-zero level of computing capacity and less than the higher level of computing capacity to run. In some aspects, the system may determine what computing resources are necessary to run the invoked application or function and provide those resources, provided that they are less than the higher level of computing capacity.

With reference to an illustrative example, a client device may submit a request to an application for a result. This request may be stored in a queue, which is monitored by the on-demand code execution system or a component thereof, such as a supervisor component executing on a host device in which the application is running. In response to the request, the supervisor component or some other component of the on-demand code execution system may determine what function should be invoked to provide the results, provision the required computing resources (if needed), and invoke the function required to obtain the result. Subsequent to obtaining the result, the supervisor component or another component of the on-demand code execution system may reduce the computing resources to a lesser non-zero level of computing capacity specified in application configuration data. Application configuration data may also specify a higher level of computing capacity necessary to execute one or more invoked function(s) or applications(s), a background process, and a request/response process. Additionally, or alternatively, the supervisor component may determine that the queue contains no additional requests prior to reducing the computing resources to the lesser non-zero level of computing capacity. If the system determines that the queue does contain additional requests, then the system may provide results for each request in the order the request was received using the process described above. For example, for each request the system may determine what application or function should be invoked to provide the result for each request, provision the required computing resources (if not already provisioned), and invoke the functions required to obtain the result. Once the queue is empty or the system otherwise determines that there are no outstanding requests to be processed, the supervisor component may reduce the computing resources to the lesser non-zero level of computing capacity sufficient for continued execution of the background process.

In some cases, the result corresponding to a specific request may not be obtained by the system. For example, the invoked function or functions required to obtain the result may fail. In such cases, the supervisor component or another component of the on-demand code execution system may access instructions including a set time period to respond to a request. The set time period may be provided in the configuration data. If the supervisor component fails to obtain a result within the set time period, the supervisor component may cancel the invoked function or functions. The supervisor component may then determine whether the queue contains any additional requests and, based on this determination, decide to reduce computing resources or maintain computing resources accordingly.

Various aspects of the disclosure will be described with regard to certain examples and embodiments, which are intended to illustrate but not limit the disclosure. Although aspects of some embodiments described in the disclosure will focus, for the purpose of illustration, management of on-demand code execution systems to fulfill user requirements for long-running background processes, the examples are illustrative only and are not intended to be limiting. In some embodiments, the techniques described herein may be applied to additional or alternative types of function code (e.g., subroutines), data sets, and on-demand code execution system configurations. Additionally, any feature used in any embodiment described herein may be used in any combination with any other feature or in any other embodiment, without limitation.

### Example Network Environment

An on-demand code execution system may provide a network-accessible service enabling users to submit or designate computer-executable source code—also referred to herein simply as “code” for brevity—to be executed by virtual machine instances on the on-demand code execution system.

Code on the on-demand code execution system may define applications with interactive, request-response-based, or otherwise short-running processes. The applications may also have long-running background processes. Users may submit a computing resource level necessary to run the background processes. This level may be a lesser non-zero level of computing capacity allocated to a virtual machine instance for running the user submitted computer executable source code. Any background process submitted by a user may be initiated on startup of a virtual machine instance of the on-demand code execution system, or triggered by some other event (e.g., after responding to an initial request, after a period of time has elapsed, etc.). Long-running background processes may include, but are not limited to, monitoring of data storage for a change in the number of items in the data storage or monitoring of a queue containing user requests to determine whether a threshold number of requests has been reached. For example, a background process may monitor the number of items in a cache and send an alert if it reaches a threshold. In a non-limiting example, the cache may be 10,000 items. If the background process notes that this threshold has been hit, it may delete the cache or call another function/application or API to perform an action in response to this threshold being hit. In some aspects, the action may be to transmit a message to a client device. As another example, a background process may be used to monitor an external storage unit (e.g., cloud storage). In a non-limiting example, a background process may be configured to run at intervals to determine whether there is a new item (e.g., a file) in the container. If a new item is found, the background process may transmit a message to a client device.

Additionally, or alternatively, code on the on-demand code execution system may define a “task,” and implement specific functionality corresponding to that task when executed on a virtual machine instance of the on-demand code execution system. Tasks may be implemented as stand-alone on-demand functions, or as features of a larger application (e.g., an application with an additional background process as described above). Individual implementations of the task on the on-demand code execution system may be referred to as an “execution” of the task (or a “task execution”). For example, the task may be implemented using a request-response protocol in which a request is received, and application or function code is invoked to respond to the request.

In some embodiments, the on-demand code execution system may enable users to directly trigger execution of an application or an individual task based on a variety of potential events, such as transmission of an API request or specially formatted hypertext transport protocol (“HTTP”) packet to the on-demand code execution system. The on-demand code execution system can therefore execute any specified executable code “on-demand,” without requiring configuration or maintenance of the underlying hardware or infrastructure on which the code is executed. Further, the on-demand code execution system may be configured to execute tasks in a rapid manner (e.g., in under 100 milliseconds [ms]), thus enabling execution of tasks in “real-time” (e.g., with little or no perceptible delay to an end user). To enable this rapid execution, the on-demand code execution system can include one or more virtual machine instances that are “pre-warmed” or pre initialized (e.g., booted into an operating system and executing a complete or substantially complete runtime environment) and configured to enable execution of user-defined code, such that the code may be rapidly executed in response to a request to execute the code, without delay caused by initializing the virtual machine instance. The pre-warmed or pre initialized virtual machine instances may be allocated a non-zero level of computing capacity to run a background process(es), such as the configurable lesser level of computing capacity described above, and begin executing the process(es) when booted. Thus, when an execution of an “on-demand” task is triggered, the code corresponding to that task can be executed within a pre-initialized virtual machine in a very short amount of time. The background process(es) may continue to run during and subsequent to the execution of the “on-demand” task.

Specifically, to execute applications or individual tasks, the on-demand code execution system described herein may maintain a pool of executing virtual machine instances that are ready for use as soon as a request to execute a task is received. Due to the pre initialized nature of these virtual machines, delay (sometimes referred to as latency) associated with executing the application code or stand-alone task code (e.g., instance and language runtime startup time) can be significantly reduced, often to sub 100 millisecond levels. Illustratively, the on-demand code execution system may maintain a pool of virtual machine instances on one or more physical computing devices, where each virtual machine instance has one or more software components (e.g., operating systems, language runtimes, libraries, etc.) loaded thereon. Any virtual machine instance may additionally be configured to run background process(es).

For example, a user may submit code necessary to begin execution of the background process(es) and provide a lesser non-zero level of computing capacity necessary to run the background process(es). The code necessary to begin execution of the background process(es) may include startup code run during bootup of a virtual machine instance and code containing data and instructions for the background process(es). In a non-limiting embodiment, the on-demand code execution system may boot a virtual machine instance with the lesser non-zero level of computing capacity allocated, and the virtual machine instance may begin executing the background process on execution of startup code provided by the user. A virtual machine instance running background process(es) may additionally execute task(s). For example, a virtual machine instance may be configured to run a background process to monitor the number of items in a cache and send an alert if it reaches a threshold. While this process is running the on-demand code execution system may receive a request to execute program code (a “task”).

When the on-demand code execution system receives a request to execute a task, the on-demand code execution system may select a virtual machine instance for executing the program code of the user based on the one or more computing constraints related to the task (e.g., a required operating system or runtime) and cause the task to be executed on the selected virtual machine instance. The tasks can be executed in isolated containers that are created on the virtual machine instances or may be executed within a virtual machine instance isolated from other virtual machine instances acting as environments for other tasks. Since the virtual machine instances in the pool have already been booted and loaded with specific operating systems and language runtimes, and optionally background process(es) by the time the requests are received, the delay associated with finding compute capacity that can handle the requests (e.g., by executing the user code in one or more containers created on the virtual machine instances) can be significantly reduced.

As used herein, the term “virtual machine instance” is intended to refer to an execution of software or other executable code that emulates hardware to provide an environment or platform on which software may execute (an example “execution environment”). Virtual machine instances are generally executed by hardware devices, which may differ from the physical hardware emulated by the virtual machine instance. For example, a virtual machine may emulate a first type of processor and memory while being executed on a second type of processor and memory. Thus, virtual machines can be utilized to execute software intended for a first execution environment (e.g., a first operating system) on a physical device that is executing a second execution environment (e.g., a second operating system). In some instances, hardware emulated by a virtual machine instance may be the same or similar to hardware of an underlying device. For example, a device with a first type of processor may implement a plurality of virtual machine instances, each emulating an instance of that first type of processor. Thus, virtual machine instances can be used to divide a device into a number of logical sub-devices (each referred to as a “virtual machine instance”). Virtual machine instances on the host device may share network bandwidth for communication with external computing resources. For example, multiple client devices may communicate with different subsets of virtual machine instances within the host device using allocated bandwidth controlled by the on-demand code-execution system. The on-demand code execution system may make adjustments to the allocations of network bandwidth based on processes being run the virtual machine instances on each host device.

While virtual machine instances can generally provide a level of abstraction away from the hardware of an underlying physical device, this abstraction is not required. For example, assume a device implements a plurality of virtual machine instances, each of which emulate hardware identical to that provided by the device. Under such a scenario, each virtual machine instance may allow a software application to execute code on the underlying hardware without translation, while maintaining a logical separation between software applications running on other virtual machine instances. This process, which is generally referred to as “native execution,” may be utilized to increase the speed or performance of virtual machine instances. Other techniques that allow direct utilization of underlying hardware, such as hardware pass-through techniques, may be used, as well.

While a virtual machine executing an operating system is described herein as one example of an execution environment, other execution environments are also possible. For example, applications, tasks or other processes may be executed within a software “container,” which provides a runtime environment without itself providing virtualization of hardware. Containers may be implemented within virtual machines to provide additional security or may be run outside of a virtual machine instance. Both virtual machine instances and containers can be configured to load and execute background process(es).

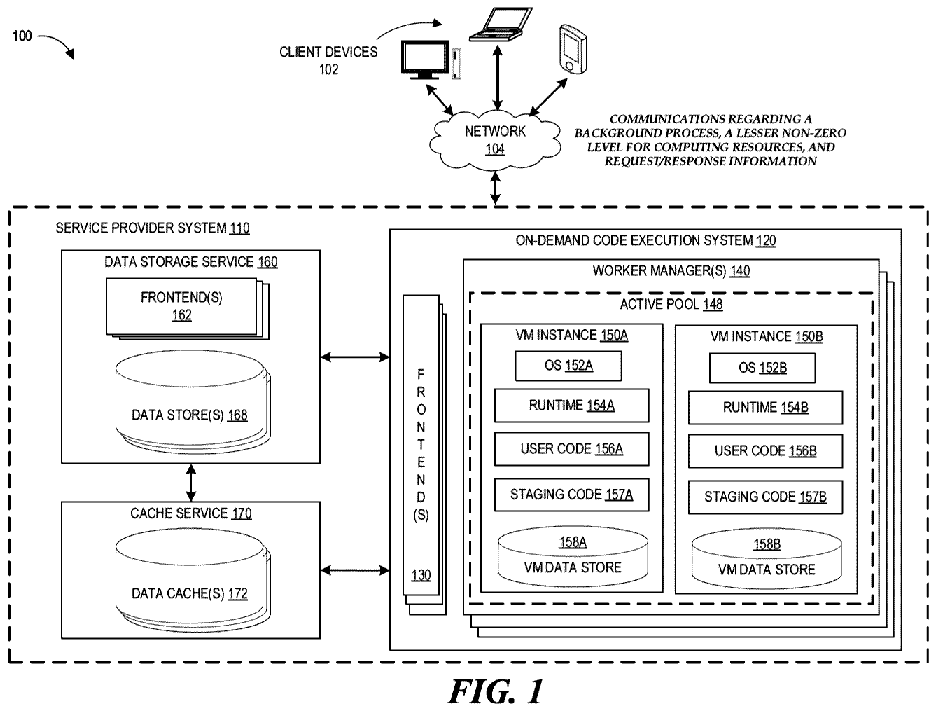

FIG. 1 is a block diagram of an illustrative operating environment 100 in which a service provider system 110 operates to enable client devices 102 to submit or request invocation of user-defined code by an on-demand code execution system 120.

By way of illustration, various example client devices 102 are shown in communication with the service provider system 110, including a desktop computer, laptop, and a mobile phone. In general, the client devices 102 can be any computing device such as a desktop, laptop or tablet computer, personal computer, wearable computer, server, personal digital assistant (PDA), hybrid PDA/mobile phone, mobile phone, electronic book reader, set top box, voice command device, camera, digital media player, and the like.

Generally described, the data storage service 160 can operate to enable clients to read, write, modify, and delete data, such as files, objects, blocks, or records, each of which represents a set of data associated with an identifier (an “object identifier” or “resource identifier”) that can be interacted with as an individual resource. For example, an object may represent a single file submitted by a client device 102 (though the data storage service 160 may or may not store such an object as a single file). This object-level interaction can be contrasted with other types of storage services, such as block-based storage in which data is manipulated at the level of individual blocks or database storage in which data manipulation may occur at the level of tables or the like.

The data storage service 160 illustratively includes one or more frontends 162, which provide an interface (a command-line interface (CLIs), application programing interface (APIs), or other programmatic interface) through which client devices 102 can interface with the service 160 to configure the service 160 on their behalf and to perform I/O operations on the service 160. For example, a client device 102 may interact with a frontend 162 to create a collection of data objects on the service 160 (e.g., a “bucket” of objects) and to configure permissions for that collection. Client devices 102 may thereafter create, read, update, or delete objects within the collection based on the interfaces of the frontends 162. In one embodiment, the frontend 162 provides a REST-compliant HTTP interface supporting a variety of request methods, each of which corresponds to a requested I/O operation on the service 160. By way of non-limiting example, request methods may include:
a GET operation requesting retrieval of an object stored on the service 160 by reference to an identifier of the object;
a PUT operation requesting storage of an object to be stored on the service 160, including an identifier of the object and input data to be stored as the object;
a DELETE operation requesting deletion of an object stored on the service 160 by reference to an identifier of the object; and
a LIST operation requesting listing of objects within an object collection stored on the service 160 by reference to an identifier of the collection.
   A variety of other operations may also be supported.

During general operation, frontends 162 may be configured to obtain a call to a request method and apply that request method to input data for the method. For example, a frontend 162 can respond to a request to PUT input data into the service 160 as an object by storing that input data as the object on the service 160.

Data may be stored, for example, on data stores 168, which correspond to any persistent or substantially persistent storage (including hard disk drives (HDDs), solid state drives (SSDs), network accessible storage (NAS), storage area networks (SANs), non-volatile random access memory (NVRAM), or any of a variety of storage devices known in the art). As a further example, the frontend 162 can respond to a request to access a data set or portion thereof from the service 160 by retrieving the requested data from the stores 168 (e.g., an object representing input data to a GET resource request), and returning the object to a requesting client device 102.

In some cases, calls to a request method may invoke one or more native data manipulations provided by the service 160. For example, a SELECT operation may provide an SQL-formatted query to be applied to an object (also identified within the request), or a GET operation may provide a specific range of bytes of an object to be returned.

The service provider system 110 illustratively includes a cache service 170 configured to cache data sets for code executed by the on-demand code execution system 120. Data may be cached, for example, on data caches 172, which correspond to any data storage such hard disk drives (HDDs), solid state drives (SSDs), network accessible storage (NAS), storage area networks (SANs), non-volatile random access memory (NVRAM), random access memory (RAM), or any of a variety of storage devices known in the art. Although illustrated as separate and outside of the data storage service and the on-demand code execution system 120, in some embodiments the cache service 170 may be implemented within one or both of the data storage service 160 or on-demand code execution system 120 (e.g., on physical or logical commuting systems that are part of the data storage service 160 or on-demand code execution system 120).

The client devices 102, data storage service 160, and on-demand code execution system 120 may communicate via a network 104, which may include any wired network, wireless network, or combination thereof. For example, the network 104 may be a personal area network, local area network, wide area network, over-the-air broadcast network (e.g., for radio or television), cable network, satellite network, cellular telephone network, or combination thereof. As a further example, the network 104 may be a publicly accessible network of linked networks, possibly operated by various distinct parties, such as the Internet. In some embodiments, the network 104 may be a private or semi-private network, such as a corporate or university intranet. The network 104 may include one or more wireless networks, such as a Global System for Mobile Communications (GSM) network, a Code Division Multiple Access (CDMA) network, a Long Term Evolution (LTE) network, or any other type of wireless network. The network 104 can use protocols and components for communicating via the Internet or any of the other aforementioned types of networks. For example, the protocols used by the network 104 may include Hypertext Transfer Protocol (HTTP), HTTP Secure (HTTPS), Message Queue Telemetry Transport (MQTT), Constrained Application Protocol (CoAP), and the like. Protocols and components for communicating via the Internet or any of the other aforementioned types of communication networks are well known to those skilled in the art and, thus, are not described in more detail herein.

The system 120 includes one or more frontends 130 which enable interaction with the on-demand code execution system 120. In an illustrative embodiment, the frontends 130 serve as a “front door” to the other services provided by the on-demand code execution system 120, enabling users (via client devices 102) to provide, request execution of, and view results of computer executable code. The frontends 130 include a variety of components to enable interaction between the on-demand code execution system 120 and other computing devices. For example, each frontend 130 may include a request interface providing client devices 102 with the ability to upload or otherwise communicate user-specified code to the on-demand code execution system 120 and to thereafter request execution of that code. In one embodiment, the request interface communicates with external computing devices (e.g., client devices 102, frontend 162, etc.) via a graphical user interface (GUI), CLI, or API. The frontends 130 process the requests and make sure that the requests are properly authorized. For example, the frontends 130 may determine whether the user associated with the request is authorized to access the user code specified in the request.

References to user code as used herein may refer to any program code (e.g., a program, routine, subroutine, thread, etc.) written in a specific program language. In the present disclosure, the terms “code,” “user code,” “function code,” “application code,” and “program code,” may be used interchangeably. Such user code may be executed to achieve a specific function, for example, in connection with a specific data transformation developed by the user. As noted above, individual collections of user code (e.g., to achieve a specific function) are referred to herein as “tasks,” while specific executions of that code (including, e.g., compiling code, interpreting code, or otherwise making the code executable) are referred to as “task executions” or simply “executions.” Tasks may be written, by way of non-limiting example, in JavaScript (e.g., node.js), Java, Python, or Ruby (or another programming language).

To manage requests for code execution, the frontend 130 can include an execution queue, which can maintain a record of requested task executions. Illustratively, the number of simultaneous task executions by the on-demand code execution system 120 is limited, and as such, new task executions initiated at the on-demand code execution system 120 (e.g., via an API call, via a call from an executed or executing task, etc.) may be placed on the execution queue and processed, e.g., in a first-in-first-out order. In some embodiments, the on-demand code execution system 120 may include multiple execution queues, such as individual execution queues for each user account. For example, users of the service provider system 110 may desire to limit the rate of task executions on the on-demand code execution system 120 (e.g., for cost reasons). Thus, the on-demand code execution system 120 may utilize an account-specific execution queue to throttle the rate of simultaneous task executions by a specific user account. In some instances, the on-demand code execution system 120 may prioritize task executions, such that task executions of specific accounts or of specified priorities bypass or are prioritized within the execution queue. In other instances, the on-demand code execution system 120 may execute tasks immediately or substantially immediately after receiving a call for that task, and thus, the execution queue may be omitted.

The frontend 130 can further include an output interface configured to output information regarding the execution of tasks on the on-demand code execution system 120. Illustratively, the output interface may transmit data regarding task executions (e.g., results of a task, errors related to the task execution, or details of the task execution, such as total time required to complete the execution, total data processed via the execution, etc.) to the client devices 102 or the data storage service 160.

In some embodiments, the on-demand code execution system 120 may include multiple frontends 130. In such embodiments, a load balancer may be provided to distribute the incoming calls to the multiple frontends 130, for example, in a round-robin fashion. In some embodiments, the manner in which the load balancer distributes incoming calls to the multiple frontends 130 may be based on the location or state of other components of the on-demand code execution system 120. For example, a load balancer may distribute calls to a geographically nearby frontend 130, or to a frontend with capacity to service the call. In instances where each frontend 130 corresponds to an individual instance of another component of the on-demand code execution system 120, such as the active pool 148 described below, the load balancer may distribute calls according to the capacities or loads on those other components. Calls may in some instances be distributed between frontends 130 deterministically, such that a given call to execute a task will always (or almost always) be routed to the same frontend 130. This may, for example, assist in maintaining an accurate execution record for a task, to ensure that the task executes only a desired number of times. For example, calls may be distributed to load balance between frontends 130. Other distribution techniques, such as anycast routing, will be apparent to those of skill in the art.

The on-demand code execution system 120 further includes one or more worker managers 140 that manage the execution environments, such as virtual machine instances 150 (shown as VM instance 150A and 150B, generally referred to as a “VM”), used for servicing incoming calls to execute tasks. For example, the worker manager 140 may work with a supervisor process or processes. The supervisor process may be a part of the worker manager 140 or there may be a supervisor process associated with other components of the on-demand code execution system (e.g., a host device, a virtual machine, etc.). The supervisor process(es) may allocate resources to the execution environments. Additionally, or alternatively, the supervisor process(es) may generate execution environments with specific configurations and execute relevant startup code, where present. The startup code may include instructions to begin executing background process(es). While the following will be described with reference to virtual machine instances 150 as examples of such environments, embodiments of the present disclosure may utilize other environments, such as software containers. In the example illustrated in FIG. 1, each worker manager 140 manages an active pool 148, which is a group (sometimes referred to as a pool) of virtual machine instances 150 executing on one or more physical host computing devices that are initialized to execute a given task (e.g., by having the code of the task and any dependency data objects loaded into the instance).

Although the virtual machine instances 150 are described here as being assigned to a specific task, in some embodiments, the instances may be assigned to a group of tasks, such that the instance is tied to the group of tasks and any tasks of the group can be executed within the instance. For example, the tasks in the same group may belong to the same security group (e.g., based on their security credentials) such that executing one task in a container on a specific instance 150 after another task has been executed in another container on the same instance does not pose security risks. A task may be associated with permissions encompassing a variety of aspects controlling how a task may execute. For example, permissions of a task may define what network connections (if any) can be initiated by an execution environment of the task. As another example, permissions of a task may define what authentication information is passed to a task, controlling what network-accessible resources are accessible to execution of a task (e.g., objects on the service 160). In one embodiment, a security group of a task is based on one or more such permissions. For example, a security group may be defined based on a combination of permissions to initiate network connections and permissions to access network resources. As another example, the tasks of the group may share common dependencies, such that an environment used to execute one task of the group can be rapidly modified to support execution of another task within the group.

Additionally, or alternatively, in some embodiments the instances may be executing background process(es). For example, a virtual machine instance may be allocated a lesser level of resources to run background process(es). During booting of the virtual machine, the background process(es) may begin executing. Additionally, or alternatively, the user may submit startup code which is used to begin executing the background process(es). The background processes may run during and/or subsequent to a specific task or group of tasks. For example, a virtual machine instance may be configured to run a background process to monitor the number of items in a cache and send an alert if it reaches a threshold. While this process is running, the frontend 130 may receive a request to execute a task. In some embodiments, the background process may continue to run while the task is being processed. In some embodiments, multiple additional tasks may run simultaneously while the background process continues to execute. Additionally, or alternatively, multiple requests may be received at different times by frontend 130. The tasks associated with each request may be run while the background process continues to execute.

Once a triggering event to execute a task has been successfully processed by a frontend 130, the frontend 130 passes a request to a worker manager 140 to execute the task. In one embodiment, each frontend 130 may be associated with a corresponding worker manager 140 (e.g., a worker manager 140 co-located or geographically nearby to the frontend 130) and thus, the frontend 130 may pass most or all requests to that worker manager 140. In another embodiment, a frontend 130 may include a location selector configured to determine a worker manager 140 to which to pass the execution request. In one embodiment, the location selector may determine the worker manager 140 to receive a call based on hashing the call, and distributing the call to a worker manager 140 selected based on the hashed value (e.g., via a hash ring). In another embodiment, a frontend 130 may determine a worker manager 140 or individual host to which to pass the execution request based on a prior invocation of an application on the host (e.g., the application has been instantiated and may receive requests for processing while continuing to execute a background process). Various other mechanisms for distributing calls between worker managers 140 will be apparent to one of skill in the art.

Thereafter, the worker manager 140 may modify a virtual machine instance 150 (if necessary) and execute the code of the task within the instance 150. As discussed above, the instance 150 may already be running background process(es). The worker manager 140 may modify the virtual machine instance to execute the code of the task without interrupting execution of the background process(es). As shown in FIG. 1, respective instances 150 may have operating systems (OS) 152 (shown as OS 152A and 152B), language runtimes 154 (shown as runtime 154A and 154B), and user code 156 (shown as user code 156A and 156B). The OS 152, runtime 154, and user code 156 may collectively enable execution of the user code to implement the task. Thus, via operation of the on-demand code execution system 120, tasks may be rapidly executed within an execution environment.

In accordance with aspects of the present disclosure, each VM 150 additionally includes staging code 157 executable to facilitate staging of input data on the VM 150 and handling of output data written on the VM 150, as well as a VM data store 158 accessible through a local file system of the VM 150. Illustratively, the staging code 157 represents a process executing on the VM 150 (or potentially a host device of the VM 150) and configured to obtain data from the data storage service 160 or cache service 170 and place that data into the VM data store 158. The staging code 157 can further be configured to obtain data written to a file within the VM data store 158, and to transmit that data to the data storage service 160 or cache service 170. Because such data is available at the VM data store 158, user code 156 is not required to obtain data over a network, simplifying user code 156 and enabling further restriction of network communications by the user code 156, thus increasing security. Rather, as discussed above, user code 156 may interact with input data and output data as files on the VM data store 158, by use of file handles passed to the code 156 during an execution. In some embodiments, input and output data may be stored as files within a kernel-space file system of the data store 158. In other instances, the staging code 157 may provide a virtual file system, such as a filesystem in userspace (FUSE) interface, which provides an isolated file system accessible to the user code 156, such that the user code's access to the VM data store 158 is restricted.

As used herein, the term “local file system” generally refers to a file system as maintained within an execution environment, such that software executing within the environment can access data as file, rather than via a network connection. In accordance with aspects of the present disclosure, the data storage accessible via a local file system may itself be local (e.g., local physical storage), or may be remote (e.g., accessed via a network protocol, like NFS, or represented as a virtualized block device provided by a network-accessible service). Thus, the term “local file system” is intended to describe a mechanism for software to access data, rather than physical location of the data.

The VM data store 158 can include any persistent or non-persistent data storage device. In one embodiment, the VM data store 158 is physical storage of the host device, or a virtual disk drive hosted on physical storage of the host device. In another embodiment, the VM data store 158 is represented as local storage, but is in fact a virtualized storage device provided by a network accessible service. For example, the VM data store 158 may be a virtualized disk drive provided by a network-accessible block storage service. In some embodiments, the data storage service 160 may be configured to provide file-level access to objects stored on the data stores 168, thus enabling the VM data store 158 to be virtualized based on communications between the staging code 157 and the service 160. For example, the data storage service 160 can include a file-level interface providing network access to objects within the data stores 168 as files. The file-level interface may, for example, represent a network-based file system server (e.g., a network file system (NFS)) providing access to objects as files, and the staging code 157 may implement a client of that server, thus providing file-level access to objects of the service 160.

In some instances, the VM data store 158 may represent virtualized access to another data store executing on the same host device of a VM instance 150. For example, an active pool 148 may include one or more data staging VM instances (not shown in FIG. 1), which may be co-tenanted with VM instances 150 on the same host device. A data staging VM instance may be configured to support retrieval and storage of data from the service 160 (e.g., data objects or portions thereof, input data passed by client devices 102, etc.), and storage of that data on a data store of the data staging VM instance. The data staging VM instance may, for example, be designated as unavailable to support execution of user code 156, and thus be associated with elevated permissions relative to instances 150 supporting execution of user code. The data staging VM instance may make this data accessible to other VM instances 150 within its host device (or, potentially, on nearby host devices), such as by use of a network-based file protocol, like NFS. Other VM instances 150 may then act as clients to the data staging VM instance, enabling creation of virtualized VM data stores 158 that, from the point of view of user code 156A, appear as local data stores. Beneficially, network-based access to data stored at a data staging VM can be expected to occur very quickly, given the co-location of a data staging VM and a VM instance 150 within a host device or on nearby host devices.

While some examples are provided herein with respect to use of IO stream handles to read from or write to a VM data store 158, IO streams may additionally be used to read from or write to other interfaces of a VM instance 150 (while still removing a need for user code 156 to conduct operations other than stream-level operations, such as creating network connections). For example, staging code 157 may “pipe” input data to an execution of user code 156 as an input stream, the output of which may be “piped” to the staging code 157 as an output stream. As another example, a staging VM instance or a hypervisor to a VM instance 150 may pass input data to a network port of the VM instance 150, which may be read—from by staging code 157 and passed as an input stream to the user code 157. Similarly, data written to an output stream by the task code 156 may be written to a second network port of the instance 150A for retrieval by the staging VM instance or hypervisor. In yet another example, a hypervisor to the instance 150 may pass input data as data written to a virtualized hardware input device (e.g., a keyboard) and staging code 157 may pass to the user code 156 a handle to the IO stream corresponding to that input device. The hypervisor may similarly pass to the user code 156 a handle for an IO stream corresponding to a virtualized hardware output device, and read data written to that stream as output data. Thus, the examples provided herein with respect to file streams may generally be modified to relate to any IO stream.

The data storage service 160, cache service 170, and on-demand code execution system 120 are depicted in FIG. 1 as operating in a distributed computing environment including several computer systems that are interconnected using one or more computer networks (not shown in FIG. 1). The data storage service 160, cache service 170, and on-demand code execution system 120 could also operate within a computing environment having a fewer or greater number of devices than are illustrated in FIG. 1. Thus, the depiction of the data storage service 160, cache service 170, and on-demand code execution system 120 in FIG. 1 should be taken as illustrative and not limiting to the present disclosure. For example, the on-demand code execution system 120 or various constituents thereof could implement various Web services components, hosted or “cloud” computing environments, or peer to peer network configurations to implement at least a portion of the processes described herein. In some instances, the data storage service 160, cache service 170, and on-demand code execution system 120 may be combined into a single service. Further, the data storage service 160, cache service 170, and on-demand code execution system 120 may be implemented directly in hardware or software executed by hardware devices and may, for instance, include one or more physical or virtual servers implemented on physical computer hardware configured to execute computer executable instructions for performing various features that will be described herein. The one or more servers may be geographically dispersed or geographically co-located, for instance, in one or more data centers. In some instances, the one or more servers may operate as part of a system of rapidly provisioned and released computing resources, often referred to as a “cloud computing environment.”

In the example of FIG. 1, the data storage service 160, cache service 170, and on-demand code execution system 120 are illustrated as connected to the network 104. In some embodiments, any of the components within the data storage service 160, cache service 170, and on-demand code execution system 120 can communicate with other components of the on-demand code execution system 120 via the network 104. In other embodiments, not all components of the data storage service 160, cache service 170, and on-demand code execution system 120 are capable of communicating with other components of the virtual execution environment 100. In one example, only the frontends 130 and 162 (which may in some instances represent multiple frontends) of the on-demand code execution system 120 and the data storage service 160, respectively, may be connected to the network 104, and other components of the data storage service 160 and on-demand code execution system 120 may communicate with other components of the environment 100 via the respective frontends 130 and 162.

While some functionalities are generally described herein with reference to an individual component of the data storage service 160, cache service 170, and on-demand code execution system 120, other components or a combination of components may additionally or alternatively implement such functionalities. Thus, the specific configuration of elements within FIG. 1 is intended to be illustrative.

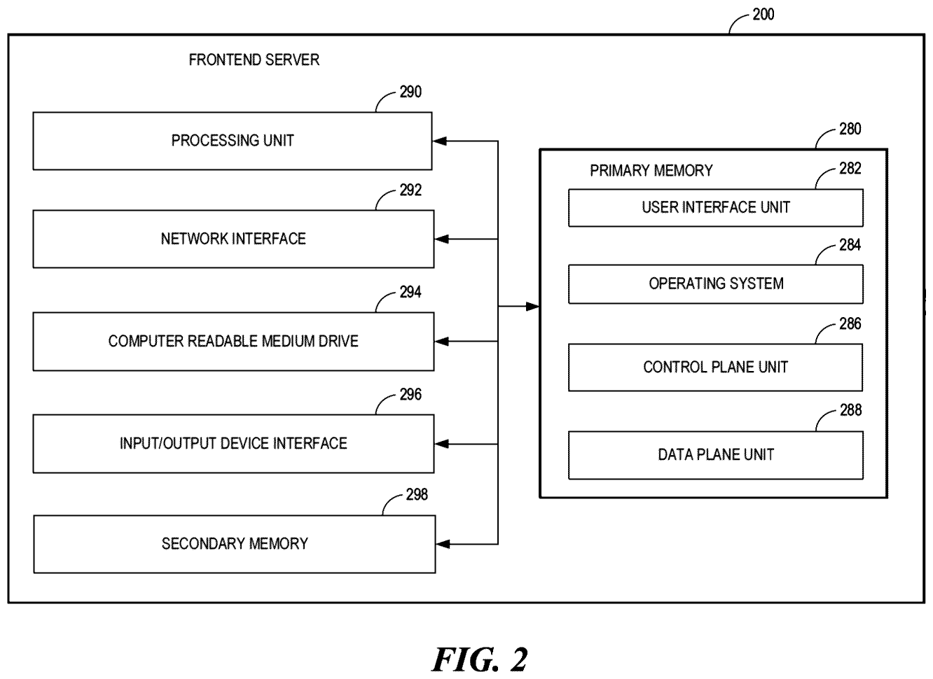

FIG. 2 depicts a general architecture of a frontend server 200 computing device implementing a frontend 162 of FIG. 1. The general architecture of the frontend server 200 depicted in FIG. 2 includes an arrangement of computer hardware and software that may be used to implement aspects of the present disclosure. The hardware may be implemented on physical electronic devices, as discussed in greater detail below. The frontend server 200 may include many more (or fewer) elements than those shown in FIG. 2. It is not necessary, however, that all of these generally conventional elements be shown in order to provide an enabling disclosure. Additionally, the general architecture illustrated in FIG. 2 may be used to implement one or more of the other components illustrated in FIG. 1.

As illustrated, the frontend server 200 includes a processing unit 290, a network interface 292, a computer readable medium drive 294, and an input/output device interface 296, all of which may communicate with one another by way of a communication bus. The network interface 292 may provide connectivity to one or more networks or computing systems. The processing unit 290 may thus receive information and instructions from other computing systems or services via the network 104. The processing unit 290 may also communicate to and from primary memory 280 or secondary memory 298 and further provide output information for an optional display (not shown) via the input/output device interface 296. The input/output device interface 296 may also accept input from an optional input device (not shown).

The primary memory 280 or secondary memory 298 may contain computer program instructions (grouped as units in some embodiments) that the processing unit 290 executes in order to implement one or more aspects of the present disclosure. These program instructions are shown in FIG. 2 as included within the primary memory 280, but may additionally or alternatively be stored within secondary memory 298. The primary memory 280 and secondary memory 298 correspond to one or more tiers of memory devices, including (but not limited to) RAM, 3D XPOINT memory, flash memory, magnetic storage, and the like. The primary memory 280 is assumed for the purposes of description to represent a main working memory of the worker manager 140, with a higher speed but lower total capacity than secondary memory 298.

The primary memory 280 may store an operating system 284 that provides computer program instructions for use by the processing unit 290 in the general administration and operation of the frontend server 200. The memory 280 may further include computer program instructions and other information for implementing aspects of the present disclosure. For example, in one embodiment, the memory 280 includes a user interface unit 282 that generates user interfaces (or instructions therefor) for display upon a computing device, e.g., via a navigation or browsing interface such as a browser or application installed on the computing device.

The memory 280 may include a control plane unit 286 and data plane unit 288 each executable to implement aspects of the present disclosure. Illustratively, the control plane unit 286 may include code executable to enable definition or submission of function code to be executed. The data plane unit 288 may illustratively include code enabling handling of I/O operations on the data storage service 160 or cache service 170, including retrieving data sets, generating data references to be used by other functions to access the data sets, caching the data sets, etc.

The frontend server 200 of FIG. 2 is one illustrative configuration of such a device, of which others are possible. For example, while shown as a single device, a frontend server 200 may in some embodiments be implemented as multiple physical host devices. Illustratively, a first device of such a frontend server 200 may implement the control plane unit 286, while a second device may implement the data plane unit 288.

While described in FIG. 2 as a frontend server 200, similar components may be utilized in some embodiments to implement other devices shown in the environment 100 of FIG. 1. For example, a similar device may implement a worker manager 140, as described in more detail in U.S. Pat. No. 9,323,556, entitled “PROGRAMMATIC EVENT DETECTION AND MESSAGE GENERATION FOR REQUESTS TO EXECUTE PROGRAM CODE,” and filed Sep. 30, 2014 (the “'556 Patent”), the entirety of which is hereby incorporated by reference.

### Example Lifecycle of a Virtual Machine

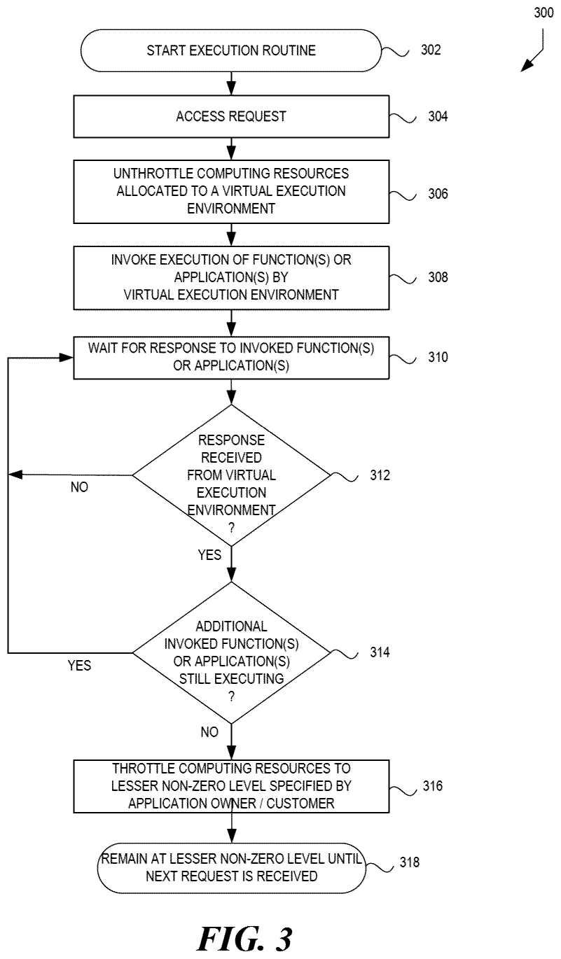

FIG. 3 illustrates an example routine 300 for managing computing resources allocated to a virtual execution environment (e.g., a virtual machine instance, a container, or another virtual computing component) during a request/response cycle. The virtual execution environment described herein may be pre-warmed or pre-initialized to run a background process, as described above with reference to FIG. 1. As a review, the virtual execution environment may be allocated a lesser non-zero level of computing capacity and may be executing a background process. The execution routine begins at block 302.

At block 304, the on-demand code execution system (e.g., on-demand code execution system 120 of FIG. 1) may access a request. The request may be submitted from a client device (e.g., client devices 102 of FIG. 1). Once submitted, the request may be processed by a frontend (e.g., frontend 130 of FIG. 1). Additionally, or alternatively, the request may be received by a request proxy of a virtual execution environment. The request proxy may be a component of a virtual execution environment configured to monitor requests from client devices. The request proxy may subsequently communicate with other components of the virtual execution environment in order to generate a response to each request. For example, requests received from client devices may be stored. Illustratively, requests received from client devices may be stored in a queue. The request proxy may retrieve and/or remove requests from the queue. The request proxy may then determine what actions need to be taken to generate a response to the request. For example, the request proxy may determine that the level of computing capacity allocated to the virtual execution environment needs to be increased and that certain functions should be invoked to obtain the response. The request proxy may then generate instructions to take these actions, as will be discussed in more detail at blocks 306 and 308.

At block 306, the on-demand code execution system may adjust the computing resources allocated to a virtual execution environment. In some embodiments, the adjustment may be to increase the level of computing capacity allocated to a virtual execution environment. Such an adjustment may be referred to as “unthrottling” the computing resources, in contrast to “throttling” the computing resources whereby the adjustment is to reduce level computing capacity allocated to the virtual execution environment. For example, a virtual execution environment allocated a lesser non-zero level of computing capacity may be unthrottled to a higher level of computing capacity, where the higher level of computing capacity is greater than the lesser non-zero level of computing capacity. In some embodiments, this action may be performed by the request proxy described at block 304. For example, in some embodiments, the request proxy may communicate with a supervisor process to unthrottle resources allocated to the virtual execution environment. Of course, in some embodiments the supervisor process may access and/or remove requests from a queue and unthrottle computing resources for a virtual execution environment in response to the request.

In some embodiments, the lesser non-zero level of computing capacity and higher non-zero level of computing capacity may be specified by the client device. For example, the client device may provide configuration data for the virtual execution environment including application and function code and a lesser non-zero level of computing capacity. In some embodiments, the configuration data may also include a higher level of computing capacity that is greater than the lesser level of computing capacity. The higher level of computing capacity may be configured to be sufficient to allow the execution of invoked function(s) or application(s). Application configuration data may also specify a background process, and a request/response process. In further embodiments, the configuration data may define a range of computing resources bounded by the lesser non-zero level of computing capacity and the higher level of computing capacity. In some embodiments, the configuration data may specify intermediate levels for each function or application configured to be run by the virtual execution environment, where the intermediate levels fall within the range of computing resources. In some embodiments, the lesser non-zero level of computing capacity may be configurable to achieve a minimum non-zero level. The higher level of computing capacity may also be configurable to achieve a maximum level of computing capacity. In some embodiments, the lesser non-zero level and the higher non-zero level may be provided in communications with the client device, such as configuration data. The client device may configure the lesser non-zero level of computing capacity to a minimum non-zero level and the higher level of computing capacity to a maximum level.

In some embodiments, the higher level of computing capacity may be specified by the supervisor process. For example, the request proxy or the supervisor process may determine that an application needs to be invoked to generate a response to a request. The supervisor process may then determine a higher level of computing capacity based on the amount of resources required to run the invoked application. The supervisor process may configure this higher level of computing capacity as a maximum level of computing capacity. The determination may be based on past data relating to computing resources allocated when the application was successful in generating the requested response as opposed to computing resources allocated when the application failed to generate the requested response. While the previous example specified an invoked application, the same process could also be applied to an invoked function. The process may also be applied to each function or application configured to run in the virtual execution environment.

As another example, the supervisor process may determine a higher level of computing capacity for a virtual execution environment based on resources allocated to other virtual execution environments under supervision by the supervisor process. For example, the supervisor process may be a component of a host device included in the on-demand code execution system. The host device may have a certain amount of computing resources, such as memory and/or network bandwidth, available for allocation to virtual execution environments which may run on the host device. The supervisor process may determine how those computing resources should be allocated to the virtual execution environments running on the host device. For example, the host device may have available computing resources including network bandwidth of 10 megabits per second (Mbps) and a processing capacity of 10 vCPUs, where each vCPU may be equivalent to a CPU core. Additionally, or alternatively, each vCPU may be equivalent to CPU time, which may be an allocation of processing time on available processing resources. If 10 virtual execution environments are running on the host device, then each device may be allocated 1 Mbps of network bandwidth and 1vCPU.

In some embodiments, each execution environment may be running a background process and be initially allocated a lesser non-zero level of computing capacity out of the available computing resources of the host device. The remainder of the available computing resources may be allocated as needed to enable task execution by the virtual execution environments. For example, referring back to the previous example, 10 virtual machines may run on a host device with available computing resources including a network bandwidth of 10 Mbps and a processing capacity of 10 vCPUs. The lesser non-zero level for each environment may be 0.1 Mbps and 0.1 vCPU. Accordingly, the remainder of the available computing resources may be 9 Mbps and 9 vCPU. Typically, a virtual execution environment may have a higher level of computing capacity of less than the remainder of the available computing resources (e.g., 2 Mbps or 2 vCPU). However, the total of the higher level of computing capacity for each virtual environment on the host computing device may exceed the remainder of the available computing resources (e.g., if 10 virtual execution environments had a total higher level of 12 vCPUs). Such a scenario—which may be referred to as oversubscription—may nevertheless be managed so as not to negatively affect the virtual execution environments (e.g., by provisioning virtual execution environment together that are unlikely to require their respective higher levels of computing capacity concurrently).

In some embodiments, a user may configure a virtual execution environment to have a higher level of computing capacity that greater than the total available computing resources (e.g., higher level of 9.1 Mbps and 9.1 vCPU in the example above). If the request proxy generates instructions to unthrottle (e.g., increase) resources associated with the virtual execution environment to a higher level that is above the total available level, the supervisor process may allocate the remainder of the available computing resources to that virtual execution environment.

Although the examples above have the same lesser non-zero level for each virtual execution environment, the lesser non-zero level may vary between virtual execution environments. The allocation of the available computing resources may be shifted between virtual execution environments of the host device provided that the amount of computing resources allocated to all of the virtual execution environments of the host device is within the available computing resources of the host device and each virtual execution environment is allocated at least the lesser non-zero level of computing capacity for that virtual execution environment. For example, a virtual execution environment may be configured such that the computing resources allocated to the virtual machine may fall within a range defined by a lesser non-zero level and a higher level. In addition, multiple virtual execution environments may be unthrottled simultaneously, provided that the amount of computing resources allocated to all of the virtual execution environments of the host device is within the available computing resources of the host device.

In a non-limiting embodiment, the computing resources for a virtual execution environment may not be unthrottled because the computing resources were already unthrottled to actively process another request. For example, a first request may be accessed and/or removed from a queue by the request proxy. Based, at least in part, on the request, the request proxy may instruct the supervisor process to unthrottle resources to a higher level and/or invoke an application to generate a first response to that request. While the virtual execution environment was generating the first response, the request proxy may access and remove a second request from the queue. Because the computing resources would still be unthrottled to a higher level to generate the first response the first request, the resources would not be further unthrottled to generate a second response to the second request.

In some embodiments, the supervisor process may be a component of a worker manager (e.g., worker manager 140) and determine the level of computing capacity allocated to each virtual execution environments (e.g., virtual machines, containers, etc.) hosted by the worker manager. For example, a worker manager may have access to certain amount of computing resources. Those computing resources are available to be allocated to the virtual execution environments hosted by the worker manager. Each virtual execution environment may be allocated a lesser non-zero level of computing capacity. Each virtual execution environment may be allocated additional computing resources from the remainder of the available computing resources accessible to the worker manager, as described above with respect to the example of host devices. In some embodiments, other components of the on-demand code execution system (e.g., a host device, a virtual machine, etc.) may include a supervisor process. The supervisor process may have access to available computing resources for a worker manager, host device, or similar entity. The amount of available computing resources may vary based on demands of other virtual execution environments of the worker manager, host device, or similar entity. The supervisor process may be configured to request allocation of computing resources, greater than the lesser non-zero level, necessary to generate a response to request(s). For example, a higher level of computing capacity may be defined within the configuration data for the virtual execution environment. The supervisor process may request the higher level of computing capacity from a host device to generate a response to a request. The host device or a component of the host device may be configured to provide the higher level of computing capacity to the virtual execution environment, if available. If the higher level of computing capacity is not available, the host device or a component of the host device may be configured to allocate the available resources to the virtual execution environment.

At block 308, the on-demand code execution system may invoke execution of application(s) or function(s) on the virtual execution environment. In some embodiments, the on-demand code execution system may invoke the execution of multiple applications and/or functions in response to requests from a client device. In further embodiments, the response for each request may be generated in the order received. For example, a first request may be received from the client device. To generate a first response, the on-demand code execution system may invoke one or more functions. In embodiments with multiple functions, the functions may be executed in a pre-determined order to complete a set of processing tasks and generate the first response. Additionally, or alternatively, the on-demand code execution system may invoke an application to perform various processing tasks and generate the first response. The application may call one or more functions to execute these tasks. While the first response is being generated, a second request may be received from the client device. The on-demand code execution system may wait until the first response has been generated or until a set response period has timed out to invoke function(s) or application(s) to generate the second response.

In some embodiments, responses for multiple requests may be generated simultaneously. For example, the on-demand code execution system may receive a first request from a client device and invoke function(s) or application(s) to generate a first response to this request. While generating the first response, the on-demand code execution system may receive a second request from the client device. Without waiting for the until the first response has been generated or until a set response period has timed out, the on-demand code execution system may invoke function(s) or application(s) to generate the second response.

In some embodiments, the requests may be executed in order of importance. In some embodiments, each request may contain data indicating its importance with respect to the execution of other requests. For example, a request of high importance may contain an exclamation point or the text “High Importance.” A request of medium importance may contain an exclamation point or the text “Medium Importance,” and a request of low importance may contain an exclamation point or the text “Low Importance.” In a non-limiting embodiment, a first request of medium importance may be received, a second request of high importance may be received, and a third request of low importance may be received simultaneously or in quick succession. The on-demand code execution system may generate a first response to the second request, followed by a second response to the first request, followed by a third response to a third request.

At blocks 310 and 312, the on-demand code execution system may determine whether a first response has been generated by the invoked function(s) or application(s). The determination may occur through receipt of the first response by a request proxy. In some embodiments, the virtual execution environment used to generate the first response may send the first response, once generated, to a request proxy. The request proxy may then forward the response to the client device. The client device may be the client device that initiated the request. Additionally, or alternatively, the client device that initiated the request may belong to a group of client devices which share a unique identifier. In some embodiments, the request proxy may forward the first response to all client devices of that group. In other embodiments, the request proxy may forward the first response to a subset of client devices of that group.

Additionally, or alternatively, after invoking the function(s) or application(s) as described above with respect to block 308, the request proxy may determine whether the response has been generated by monitoring the execution of the function(s) or application(s) and determining whether they have successfully executed. If they have successfully executed, the request proxy may retrieve the response and forward the response to a client device. Additionally, or alternatively, the supervisor process may obtain the response from the function/application and then provide it to the request proxy. Once a response is obtained, the on-demand code execution system may proceed to block 314 to determine whether additional invoked function(s) or application(s) are still executing. In some embodiments, the application may not generate a response at the completion of a particular function or task, or the response may be a confirmation or completion message that is not intended to be forwarded on to a client device (e.g., a confirmation that is only to be logged).

If no response is received or obtained by the request proxy, the on-demand code execution system may repeat blocks 310 and 312 until a response is received. Additionally, or alternatively, the on-demand code execution system may repeat blocks 310 and 312 for a set time period. If a response is not received or obtained during that set time period, the on-demand code execution system may proceed to block 314 to determine whether additional invoked function(s) or application(s) are still executing. In some embodiments, the set time period is provided in the configuration data for the virtual execution environments. In some embodiments, the on-demand code execution system may have a standard set time period for all virtual execution environments. In some embodiments, the set time period may be 15 minutes.

At block 314, the on-demand code execution system may determine whether additional function(s) or application(s) are still executing after the receipt of the first response or the timeout of a set time period to obtain a first response. The additional function(s) or application(s) may be associated with the generation of the first response. For example, the additional function(s) may be running to delete intermediate data created during the generation of the first response. Additionally, or alternatively, the additional function(s) or application(s) may have been invoked by the on-demand code execution system during the generation of a second response, where the second response is generated after receipt of a second request.

After determining that no additional function(s) or application(s) are still executing, the on-demand code execution system may determine whether additional requests have been received. For example, a request proxy may check a queue used to store received requests. If the queue is empty, the on-demand code execution system may proceed to throttle computing resources at block 316, where throttling computing resources decreases the computing capacity to the lesser non-zero level.

At block 316, the on-demand code execution system may throttle computing resources for the virtual execution environment to a lesser non-zero level. In some embodiments, the lesser non-zero level may be specified by a user. For example, the user may communicate the lesser non-zero level to the on-demand code execution system as part of configuration instructions. In some embodiments, the user may configure the lesser non-zero level as a minimum non-zero level in the configuration instructions. Additionally, or alternatively, the user may communicate the lesser non-zero level to the on-demand code execution system as part of a request. In some embodiments, the user may configure the lesser non-zero level as a minimum non-zero level in the request. In some embodiments, the user may be associated with a customer account. For example, a customer account may be associated with a unique identifier. Each user associated with that customer account may share the unique identifier. Accordingly, the on-demand code execution system may accept communications associated with the unique identifier even if the communications come from multiple users.

The lesser non-zero level may be sufficient to continue execution of background process(es) of the virtual computing environment. For example, a virtual execution environment may be executing a background process at a first time. The virtual execution environment may continue executing the background process during the generation of a request to an on-demand request. After the response is received or the set time period to generate the response has timed out, the on-demand code execution system may check for additional requests as discussed above with respect to block 314. If there are no requests, the request proxy may communicate with the supervisor process to throttle resources to the virtual execution environment to a lesser non-zero level.

At block 318, the on-demand code execution system may remain at the lesser non-zero level until the next request is received. As discussed above, the background process(es) may still be executing. For example, background processes may include, but are not limited to, monitoring of data storage for a change in the number of items in the data storage or monitoring of a queue containing user requests to determine whether a threshold number of requests has been reached. On receipt of a new request, blocks 302-318 may repeat to generate a response to this request.

In some embodiments, a background process may communicate with another computing system during execution. For example, a background process may be used to monitor an external storage location (e.g., cloud storage). In a non-limiting example, a background process may be configured to run at intervals to determine whether there is a new item (e.g., a file) in the external storage location. If a new item is found, the background process may process the file, move the file to another location, transmit a message to the client device, or perform some other operation. If a message is sent to the client device, then the client device may take further action in response to the message. For example, the client device may transmit a new request to the on-demand code execution system in response to this message. Blocks 302-318 may repeat to generate a response to this request.

In some embodiments, the background process may cease executing. For example, the server including the virtual execution environment may fail. Another example may be the timeout of a virtual execution environment. For example, the virtual execution environment may be hosted by a host device. The host device may host the virtual machine for a predetermined time period. In a non-limiting embodiment, the pre-determined time period may be 6 hours. A background process may also stop executing when the customer deletes the application For example, the customer may send a request to a frontend that they no longer wish to have the virtual execution environment hosted on the host device.

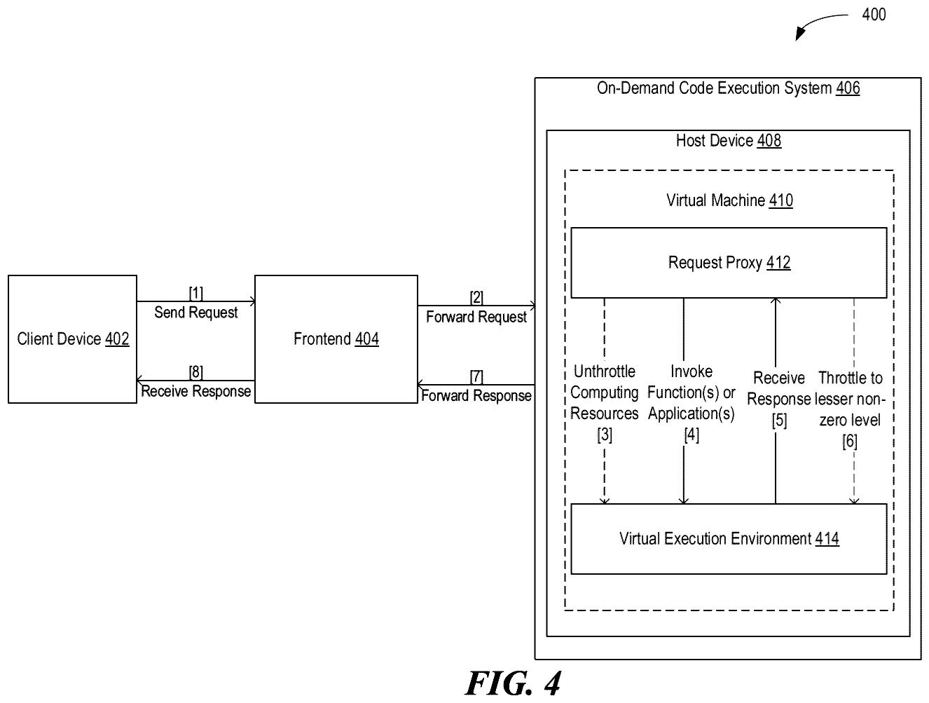

FIG. 4 illustrates a diagram depicting interactions 400 between a client device and components of an on-demand code execution system 406 during processing of a first request. Client device 402 may be any computing device such as a desktop, laptop or tablet computer, personal computer, wearable computer, server, personal digital assistant (PDA), hybrid PDA/mobile phone, mobile phone, electronic book reader, set top box, voice command device, camera, digital media player, and the like. In some embodiments client device 402 may be one of client device(s) 102 of FIG. 1.

At [1], client device 402 may send a request. The request may include one or more tasks that the client device 402 requests to have executed to generate a specific response. Additionally, or alternatively, the request may contain data indicative of the importance of the request, such as a text string with the phrase “High Importance.” In some embodiments, the request may contain additional data required for task execution. For example, the request may contain a level of computing capacity required to provide a response to the request. The level of computing capacity may be between a lesser non-zero level of computing capacity and a higher level of computing capacity specified in configuration data for the virtual execution environment 414. In some embodiments, the virtual execution environment 414 may be a container for a customer application where the customer application may include function(s) which may be invoked by the request proxy 412. The request may also contain the data locations where the on-demand code execution may access any additional data required for task execution.

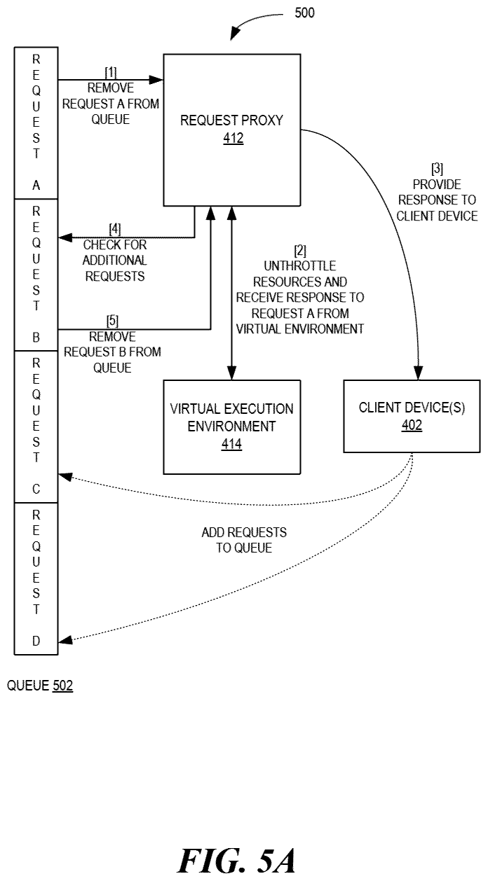

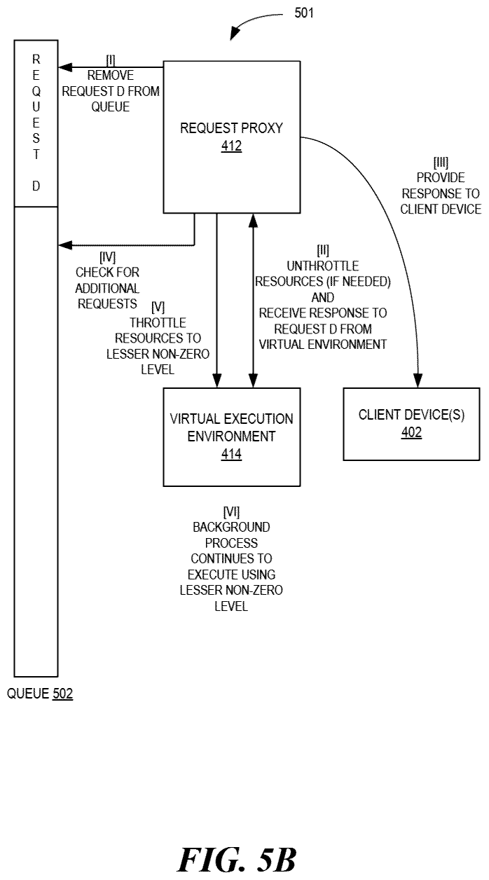

The client device 402 may transmit the request to a frontend, such as frontend 404. The frontend 404 may be external to the on-demand code execution center. Additionally, or alternatively, the client device 402 may transmit the request to a data storage, and the frontend 404 may retrieve the request from that data storage. In some embodiments the data storage may be a request queue, as will be discussed in more detail in FIGS. 5A-B. The frontend 404 may then forward the request at [2] to a component of the on-demand code execution system 406, such as the request proxy 412. Additionally, or alternatively, the frontend 404 may transmit the request to a data storage, such as a queue, and the request proxy 412 may retrieve the request from that queue.

In some embodiments, the on-demand code execution system 406 may contain one or more frontends (e.g., frontends 130 of FIG. 1). For example, the client device 402 may transmit the request to the on-demand code execution system. A frontend 130 may receive and process the request prior to providing the request to another component of the on-demand code execution system. Additionally, or alternatively, the client device 402 may transmit the request to a data storage, such as a queue, and the frontend 130 may retrieve the request from that data storage. The frontend 130 may then transmit the request to another component of the on-demand code execution system 406 including, but not limited to, host device 408, virtual machine 410, request proxy 412 or the virtual execution environment 414. For example, the frontend 130 may transmit the request to the request proxy 412. Additionally, or alternatively, the frontend 130 may transmit the request to a data storage, such as a queue, and the request proxy 412 may retrieve the request from that queue.

In some embodiments, both external frontends and internal frontends may be used to receive the request from the client device 402. For example, the client device may send a request to the external frontend 404 at [1]. The frontend 404 may forward the request at [2] to the on-demand code execution system at [2], and the on-demand code execution system may receive the request through one or more internal frontends (e.g., frontends 130 of FIG. 1). The request may be forwarded to components of the on-demand code execution system for processing. For example, the request may be forwarded to the request proxy 412 for processing. Additionally, or alternatively, an internal frontend may transmit the request to a data storage, such as a queue, and the request proxy 412 may retrieve the request from that queue.

The request proxy may be a component of the virtual machine 410, where the virtual machine 410 is hosted on host device 408, and host device 408 is a component of the on-demand code execution system 406. The request proxy may generate instructions to one or more virtual execution environments of the virtual machine 410. For example, the request proxy 412 may access the request, as described above, determine that a response can or should be generated to this request by virtual execution environment 414, and generate instructions based on the request to virtual execution environment 414. Virtual execution environment 414 may already be running background process(es) using a minimum non-zero level of computing capacity allocated to virtual execution environment 414.

In some embodiments, the virtual execution machine 410 may be an execution environment for a specific application, and the virtual machine may include a one or more virtual execution environments 414 for the application, such as one or more containers for the specific application. The request proxy may determine, based, at least partly, on the request that the specific application needs to be invoked to generate a response to the request. Additionally, or alternatively, the request proxy may determine based at least partly on the request that specific function(s) that are configured to be run in specific pre-initialized virtual execution environment need to be invoked to generate a response to the request. After making this determination, the request proxy 412 may generate instructions for that specific virtual execution environment, where the instructions may include instructions to unthrottle computing resources to the virtual execution environment and to invoke the required function(s) and/or applications. For example, the request proxy 412 may generate instructions to unthrottle computing resources and invoke function(s) or application(s) of the virtual execution environment 414 to generate a response to the request. In some embodiments, the request proxy 412 may generate instructions to more than one virtual execution environment. For example, the request proxy may determine that more than one virtual execution environment of the application (e.g., more than one container) is needed to generate a response to a request. Additionally, or alternatively, the request proxy may receive multiple requests where each request requires a function(s) and/or application(s) configured to be executed on different virtual execution environments Accordingly, the request proxy 412 may generate instructions for the multiple virtual execution environments to generate responses to the multiple request. The instructions to unthrottle the computing resources may be directed to a supervisor process, as described above with respect to FIG. 3 at block 306. In some embodiments, the supervisor process may be a component of the on-demand code execution system 406 and control resource allocation to host devices of the on-demand code execution system 406, such as host device 408.

In some embodiments, there may be a supervisor process that is a component of the host device 408 and controls resources allocated to virtual machines, such as virtual machine 410 hosted on the host device 408. The supervisor process of the host machine may operate in addition to a supervisor process of the on-demand code execution system 406. Of course, the supervisor process of the host device 408 may be the only supervisor process used to control resource allocation.

In some embodiments, there may be a supervisor process that is a component of the virtual machine 410 and controls resources allocated to virtual execution environments within the virtual machine 410. This supervisor process may operate in addition to a supervisor process of the host device 408 and/or the on-demand code execution system 406. Of course, the supervisor process of the virtual machine 410 may be the only supervisor process used to control resource allocation.

The request proxy 412 of a virtual machine 410 may work alone or with supervisor process(es) to generate a response to a request. For example, the request proxy 412 may access a request. Based, at least partly on this request, the request proxy 412 may send instructions to a supervisor process of the virtual machine 410 to unthrottle computing resources. The supervisor process may unthrottle computing resources as indicated by the dashed line at [3], where unthrottling computing resources refers to increasing the computing resources allocated to a virtual execution environment (e.g., virtual execution environment 414 of FIG. 4). For example, when the supervisor process receives instructions to unthrottle computing resources, it may allocate a higher level of computing capacity to the virtual execution environment 414. This higher level of computing capacity may be configured as a maximum level of computing capacity. Of course, the supervisor process may also allocate an intermediate level of computing capacity between a lesser non-zero level and a higher level of computing capacity, as discussed above with respect to block 306 of FIG. 3. Alternatively, the request proxy 412 may directly unthrottle computing resources at [3] without using a separate supervisor process to do so.

In some embodiments, a supervisor process of the virtual execution machine 410 may communicate with a supervisor process of the host device 408, and/or a supervisor process of the on-demand code execution system 406 to request allocation of a higher level of computing capacity to the virtual execution environment 414. The higher level of computing capacity may be defined in configuration data for the virtual execution environment 414. In some embodiments, the higher level of computing capacity may be configured as a maximum level of computing capacity. Illustratively, the configuration data may configure the higher level of computing capacity as a maximum level of computing capacity. Once the resources allocated to the virtual execution environment 414 are increased to the higher level of computing capacity, the request proxy 412 may generate instructions to invoke function(s) or application(s) at [4] on virtual execution environment 414. Of course, in some embodiments, the request proxy 412 may simultaneously unthrottle computing resources at [3] and instructions to invoke function(s) or application(s) at [4].

The invoked function(s) or application(s) may generate a response to the request and forward this response at [5] to the request proxy 412. Additionally, or alternatively, the supervisor process may receive the response to the request from the invoked function(s) or application(s) and forward this response at [5] to the request proxy 412.

The request proxy 412 may receive the requested response at [5], transmitted by the virtual machine or a component of the virtual machine. Once the response is received, in some embodiments, the request proxy 412 may initiate throttling of the computing resources to a lesser non-zero level at [6]. The lesser non-zero level may also be referred to as a lesser level for brevity. Of course, in other embodiments, request proxy 412 may first forward the response to frontend 404 or the client device 402 at [7] prior to initiating throttling the computing resources to a lesser non-zero level at [6].

In some embodiments, the virtual execution environment may transmit the response to data storage. For example, the virtual execution environment 414 may contain an internal data storage to store responses generated for multiple requests. The request proxy 412 may obtain the response for the request sent by the client device 402 at [1] from this data storage. Additionally, or alternatively, the virtual execution environment 414 may transmit the response to a data storage of the on-demand code execution system 406 or a component of on-demand code execution system 406 including, but not limited to host device 408, virtual machine 410. Request proxy 412 may obtain the response from this data storage at [6]. After receiving the response, request proxy 412 may forward the response to frontend 404 at [7]. Frontend 404 may then forward the response to the client device 402, which receives the forwarded response at [8]. In some embodiments, the virtual execution environment 414 may transmit the response to frontend 404 or otherwise cause the response to be send to the client device 402 without use of a request proxy 412.

While the illustrative interactions discussed above with respect to FIG. 4 are discussed with respect to generating a response for one request, multiple requests may be processed. For example, the client device 402 may send multiple requests simultaneously at [1] to frontend 404. Frontend 404 may forward these requests to on-demand code execution system 406 at [2]. Frontend 404 may order these requests prior to forwarding the requests to on-demand code execution system 406 at [2]. For example, each request may contain an indication of importance. For example, the requests may include text strings such as “high importance,” “medium importance” “low importance.” Additionally, or alternatively, the requests may include a number generated by the client to indicate their importance. For example, the requests including lower numbers may be less important than requests including higher numbers. Instead of forwarding the requests simultaneously, as received, frontend 404 may send requests in the order of importance. Of course, frontend 404 may generate a table indicating the order in which the requests should be executed and forward this table with the request to on-demand code execution system 406 at [2]. Additionally, a frontend of on-demand code execution system 406 (e.g., frontend 130 of FIG. 1) may order the requests. For example, the frontend of the on-demand code execution system 406 may place the requests into a queue in the by the importance ranking described above. Other components of on-demand code execution system 406 including, but not limited to, the host device 408, virtual machine 410, and request proxy 412 may order the requests in the manner described above with respect to frontend 404.

In some embodiments, client device 402 may send additional requests while a request is executing on on-demand code execution system 406. For example, client device 402 may send a first request at [1] to frontend 404. Frontend 404 may forward the request to on-demand code execution system 406. The request may be accessed by the request proxy 412. For example, on-demand code execution system 406 or one or more components of 406 may place the first request into temporary data storage, such as a cache or a queue, and request proxy 412 may retrieve the first request from that data storage. Once the first request is retrieved by request proxy 412, request proxy 412 may initiate unthrottling of the computing resources to a level greater than a lesser non-zero level of computing capacity. This level may be a higher level of computing capacity or an intermediate level of computing capacity between a higher level of computing capacity and a lesser non-zero level of computing capacity. Request proxy 412 may subsequently or simultaneously invoke function(s) or application(s) using virtual execution environment 414 to generate a first response to the first request. While those function(s) or application(s) are processing, request proxy 412 may access a second request in the manner described above with respect to the first request. Request proxy 412 may initiate unthrottling of further computing resources to generate a second response to the second request. Additionally, or alternatively, the request proxy 412 may not unthrottle additional computing resources to generate a second response for the second request. For example, in some embodiments, the computing resources for virtual execution environment 414 may already by unthrottled to a higher level of computing capacity and there is no further unthrottling that may occur. Regardless, request proxy 412 may invoke function(s) or applications to generate a second response to the second request. and transmit the first response and second response back to client device 402. Request proxy 412 may transmit the first response prior to transmitting the second response, or, in some embodiments, request proxy 412 may transmit the responses simultaneously. For example, request proxy 412 may receive the first response and second response from virtual execution environment 414 at the same time instead of receiving the first response and then the second response because the first response may take longer to generate than the second response in some embodiments. Additionally, or alternatively, request proxy 412 may hold responses for a period of time and transmit responses received during that period in a batch to frontend 404 or client device 402. In some embodiments, request proxy 412 may wait until no further requests are received for a set period of time prior to throttling computing resources for virtual execution environment 414 to a lesser non-zero level at [6].

FIG. 5A illustrates a set of example interactions 500 between components where a queue 502 is used to handle multiple requests received from client devices 402. The virtual execution environment 414 illustrated in FIG. 5A may initially be allocated a lesser non-zero level of computing capacity and be initialized to executing background process(es). Responses to additional requests received through the processes described below may be generated by executing invoked function(s) and applications in addition to the executing background process(es).

Returning to FIG. 5A, a “queue” or “queues” are used herein in accordance with its usual and customary meaning in the field of computer technology and refer to a linear data structure that is open at both ends to facilitate performance of operations in order of receipt. In some embodiments, each virtual execution environment 414 may have its own queue. For example, requests to be executed by invoking function(s) or application(s) on a virtual execution environment 414 may be stored in the same queue. Additionally, or alternatively, a queue may be provided for a larger component of an on-demand code execution system including, but not limited to, a host device, a worker manager, or a virtual machine, as described in FIG. 4. The queue for the larger component may be processed by a frontend of on-demand code execution system 406 (e.g., frontends 130 of FIG. 1) and split into smaller queues for smaller components including, but not limited to, virtual execution environments, such as virtual execution environment 414. As discussed above, virtual execution environment 414 may include containers.

In some embodiments, client device(s) 402 may be the same as client devices 102 of FIG. 1. Client device(s) 402 may add requests to the queue 502 any time after the data structure for the queue 502 is created. In some embodiments, the data structure for the queue 502 may be created on booting a virtual execution environment 414. In some embodiments, requests may be received simultaneously by the queue 502. For example, client device(s) 402 may transmit multiple requests for addition to the queue at the same time. In some embodiments, the simultaneously-received requests may be incorporated into the queue in a random order. However, in some embodiments, the simultaneously received requests may be incorporated into the queue in order of importance. For example, a first request and a second request may be received simultaneously by an on-demand code execution system or a component of the on-demand code execution system. The first request may include an indication of high importance, such as the text string “high importance.” The second request may include an indication of low importance, such as the text string “low importance.” Based, at least in part, on these importance indicators, the first request may be stored prior to the second request in the queue 502.

In embodiments where client device(s) 402 include multiple client devices, the client device(s) 402 may share a unique identifier that may be used in configuring handling of requests from client device(s) 402. For example, requests from client device(s) which share a unique identifier may be added to the same queue. Responses generated for those requests may be transmitted to all client device(s) sharing the unique identifier. Of course, in some embodiments, responses generated for those requests may be transmitted to a subset of the client device(s) sharing the unique identifier. In some embodiments, the request may identify the subset of client device(s) to which the response for a request should be provided.

Request proxy 412 may remove requests from the queue 502 at [1]. For example, the request proxy 412 may retrieve request A from the queue 502 and simultaneously delete request A from queue 502. However, in some embodiments, request proxy 412 may delete request A from queue 502 after retrieving request A from queue 502. In some embodiments, request proxy 412 may instruct another component of the on-demand code execution system to delete request A from the queue 502. For example, the on-demand code execution system may include a queue manager which may remove request A after request proxy 412 transmits a notification that it has retrieved request A.

After retrieving request A, request proxy 412 may communicate with virtual execution environment 414 at [2] to obtain a response A to request A. In some embodiments, the request proxy 412 may generate instructions based, at least partly, on request A. The instructions may be transmitted directly to virtual execution environment 414. However, in some embodiments, the instructions may be transmitted to a supervisor process. In some embodiments, the supervisor process may be a component of the machine 410. Additionally, or alternatively, the supervisor process may also be a subcomponent of another component of the on-demand code execution system.

The instructions may include instructions to unthrottle resources and invoke function(s) or application(s) configured to execute on virtual execution environment 414 to obtain a response A to request A, as discussed above with respect to FIG. 3 at blocks 306 and 308. The instructions may be transmitted directly to virtual execution environment 414. For example, request proxy 412 may determine that generating a response A to request A requires invoking specific function(s) and or application(s). Accordingly, request proxy 412 may generate instructions for virtual execution environment 414 to invoke the specific function(s) or application(s).

In some embodiments, request proxy 412 may also generate instructions to unthrottle computing resources to an increased level of computing capacity. This increased level may be a higher level of computing capacity. In some embodiments, the higher level of computing resources may be configured as a maximum level of computing capacity. The increased level may also fall within a range defined by a lesser non-zero level of computing capacity and a higher level of computing capacity. The increased level of computing capacity may be received from the client device. For example, the increased level of computing capacity may be received in configuration data provided for the client device to configure virtual execution environment 414. Additionally, or alternatively, the increased level of computing capacity may be provided in the requests. For example, request A may include an increased level of computing capacity to allocate in order to complete a set of tasks. Request proxy 412 may process this request and generate a request to unthrottle resources to the increased level of computing capacity and to invoke specific function(s) or application(s).

Of course, in some embodiments, instructions to unthrottle computing resources may not be generated or transmitted. For example, in some embodiments virtual execution environment 414 may be in the process of generating a response A to request A. Computing resources may have been unthrottled to a higher level to generate the response A to request A. Accordingly, when request B is accessed, request proxy 412 may not generate further instructions to unthrottle computing resources. Instead, request proxy 412 may generate instructions to invoke specific function(s) or application(s) to generate a response B to request B. In further embodiments, response B and response A may be generated simultaneously and transmitted to client device(s) 402 at the same time. In some embodiments, response B and response A may be generated within a predefined time interval. For example, the first response generated may be held for the predefined time interval. Other responses generated during that period will also be held until the end of the predefined time interval. At the end of the predefined time interval, all held responses will be transmitted to client device 402. In some embodiments, the predefined time interval may be defined by the client device in the configuration data.

In some embodiments, once response A has been generated by virtual execution environment 414 it may be transmitted to request proxy 412. Once request proxy 412 receives the response A, request proxy 412 may provide response A to the client device(s) 402 at [3]. Request proxy 412 may also check for additional requests in the queue 502 at [4]. This may occur prior to, subsequent to, or simultaneous to transmitting the response to client device(s) 402 at [3].

As an example of checking queue 502 prior to providing response A to client device(s) at [3]. Request proxy 412 may check the queue 502 at intervals. The intervals may occur during processing of request A and/or during generation of response A, which are steps that occur prior to generation of response A. As an example of checking the queue 502 subsequently to providing response A to client device(s) at [3], request proxy 412 may receive response A transmit response A to client device(s) 402 at [3]. Request proxy 412 may then determine whether any requests remain in the queue prior to throttling computing resources allocated to virtual execution environment 414 to a lesser non-zero level, as discussed at block 316 of FIG. 3.

At [4], request proxy 412 may check for additional requests stored in queue 502 and determine that there are additional requests present. For example, request proxy 412 may determine that request B is present in the queue 502. Request proxy 412 may subsequently remove request B from queue 502, as described above at [1] with respect to request A. A response B for request B may subsequently be generated in the manner described above with respect to steps [1]-[4] for request A. This process may be repeated for all requests remaining in the queue 502, such as request C and request D. Request proxy 412 may not generate instructions to throttle computing resources to a lesser non-zero level while requests remain in the queue and/or while responses being generated for those requests in virtual execution environment 414.

If a response fails to be generated within a set time period, the invoked function(s) or application(s) associated with that request may be killed or cancelled. If no other function(s) or applications are executing, and no requests remain in the queue, request proxy 412 may generate instructions to throttle computing resources allocated to virtual execution environment 414 to a lesser non-zero level. Background process(es) may continue to execute subsequent to computing resources being throttled to the lesser non-zero level. As an example, there may be a set time period set in the configuration data for virtual execution environment 414 to generate a response for a request of 15 minutes. Virtual execution environment 414 may generate response A, response C, and response D within this set time period. However, response B may not be generated within the time period. Accordingly, the invoked function(s) or application(s) used to attempt to generate response B may be killed. If no other requests remain in the queue, and no other function(s) or application(s) are processing, besides the background process(es), request proxy 412 may throttle resources to a lesser non-zero level. Background process(es) will not be cancelled or killed and will continue to execute using the computing resources at the lesser non-zero level.

FIG. 5B illustrates a set of example interactions 501 between components where a queue 502 is used to handle multiple requests received from client devices 402. The interactions shown in FIG. 5B may occur after processing of requests A-C as shown in FIG. 5A and described above.

Queue 502 may include a request D. At [I], the request proxy request proxy 412 may remove request D from queue 502. For example, the request proxy 412 may retrieve request D from the queue 502 and simultaneously delete request D from queue 502. However, in some embodiments, request proxy 412 may delete request D from queue 502 after retrieving request D from queue 502. In some embodiments, request proxy 412 may instruct another component of the on-demand code execution system to delete request D from the queue 502. For example, the on-demand code execution system may include a queue manager which may remove request D after request proxy 412 transmits a notification that it has retrieved request D. Prior to removal of request D, responses A-C may be generated an no other function(s) or application(s) may be processing in virtual execution environment 414.

At [II], request proxy 412 may communicate with virtual execution environment 414 to unthrottle the resources allocated to virtual execution environment 414 to respond to request D, if needed. Instructions provided by request proxy 412 to unthrottle resources may be implemented by a supervisor process of virtual machine 410. Unthrottling resources may not be needed if virtual execution environment 414 has already been allocated the higher level of computing capacity during processing of a prior request. Request proxy 412 may also invoke function(s) or application(s) to generate response D.

Once response D is generated, response D may be provided to client device(s) 402 at [III]. If response D is not generated within a set time period, the function(s) or application(s) invoked to generate response D may be cancelled or killed. Regardless, the request proxy 412 may subsequently check for additional requests at [IV] and determine that no requests remain in the queue. After determining that no requests remain in the queue and that no requests are being current processed by invoked function(s) or applications in virtual execution environment 414, request proxy 412 may initiate throttling of the computing resources allocated to virtual execution environment 414 to a lesser non-zero level at [V]. The request proxy 412 may send instructions that may be implemented by a supervisor process of virtual machine 410. After virtual execution environment 414 has been throttled to a lesser non-zero level of computing capacity, the background process(es) executing on virtual execution environment 414 may continue to execute using the lesser non-zero level of computing capacity at [VI]. Request proxy 412 may continue to monitor queue 502 at intervals to check whether a request is received. If a request is received, request proxy 412 may communicate with virtual execution environment 414 to generate a response to the request using the steps described above with respect to FIGS. 5A-B.

### Terminology and Additional Considerations

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system comprising:
an on-demand code execution service comprising a set of host computing devices for on-demand execution of application code, wherein the on-demand code execution service is configured to at least:
receive, from a client device, application configuration data for an application that comprises a request-response process and a background process, wherein the application configuration data indicates a baseline set of computing resources for the background process, and a larger set of computing resources for the request-response process;
initialize execution of a virtual computing component on a host computing device, wherein the application executes within the virtual computing component, wherein the virtual computing component is provisioned with the baseline set of computing resources based, at least in part, on the application configuration data, and wherein the background process begins executing using the baseline set of computing resources;
determine that a request queue associated with the application includes a first request;
retrieve the first request from the request queue, wherein the first request is to be processed by the application;
increase computing resources provisioned to the virtual computing component to the larger set of computing resources;
send the first request to the virtual computing component, wherein the request-response process generates a response to the first request;
receive the response from the virtual computing component;
provide the response to the client device;
determine that the request queue contains no additional requests to be processed by the application; and
decrease the computing resources provisioned to the virtual computing component to the baseline set of computing resources.

2. The system of claim 1, wherein the on-demand code execution service is further configured to:
determine that the request queue includes a second request;
retrieve the second request from the request queue, wherein the second request is to be processed by the application;
increase computing resources provisioned to the virtual computing component to the larger set of computing resources;
receive the response from the virtual computing component;
provide the response to the client device;
determine that the request queue contains no additional requests from the client device to be processed by the application;
generate a response to the second request; and
decrease the computing resources provisioned to the virtual computing component to the baseline set of computing resources.

3. The system of claim 1, wherein the on-demand code execution service is further configured to:
determine that the request queue includes a second request;
retrieve the second request from the request queue, wherein the second request is to be processed by the application;
increase computing resources provisioned to the virtual computing component to the larger set of computing resources;
fail to receive the response from the virtual computing component for a set time period, wherein the set time period is provided in the application configuration data; and
decrease the computing resources to the baseline set of computing resources.

4. The system of claim 3, wherein the computing resources comprise processing capacity measured in vCPU.

5. A system comprising computer readable memory and one or more processors, wherein the system is configured to:
configure a host computing device of a code execution system with application code configured to execute a first process according to a request-response protocol and a second process that executes outside of the request-response protocol, wherein configuring the code execution system comprises allocating a first quantity of computing resources of the host computing device to execute the second process, wherein the first quantity of computing resources is a non-zero level specified in configuration data associated with the application code;
receive a first request from a second computing system;
generate a first response to the first request based at least partly on execution of the first process, wherein the code execution system provides on-demand execution of the first process by allocating a second quantity of computing resources of the host computing device, wherein the second quantity of computing resources is greater than the first quantity of computing resources;
based at least partly on generation of the first response to the first request, reduce allocation of computing resources to the first quantity of computing resources, where the second process executes using the first quantity of computing resources; and
provide the first response to the second computing system.

6. The system of claim 5, wherein the first quantity of computing resources of the host computing device comprises a first quantity of vCPUs and the second quantity of computing resources of the host computing device comprises a second quantity of vCPUs, wherein each vCPU is representative of processing capacity allocated to a virtual execution environment of host computing device.

7. The system of claim 5, wherein the first quantity of computing resources of the host computing device comprises a first quantity of network bandwidth and the second quantity of computing resources of the host computing device comprises a second quantity of network bandwidth.

8. The system of claim 5, wherein the first quantity of computing resources of the host computing device is sufficient to allow at least one background process to execute.

9. The system of claim 5, wherein the system configures the code execution system based at least partly on the configuration data, wherein the configuration data is provided by a customer with which the application code is associated.

10. The system of claim 9, wherein the configuration data comprises a baseline set of computing resources indicating the first quantity of computing resources.

11. The system of claim 10, wherein the configuration data further comprises a larger set of computing resources indicating the second quantity of computing resources.

12. The system of claim 9, wherein the configuration data comprises an intermediate set of computing resources indicating a third quantity of computing resources, wherein the third quantity of computing resources is greater than the first quantity of computing resources and less than the second quantity of computing resources.

13. A computer-implemented method comprising:
under control of a computing system comprising one or more computing devices configured to execute specific instructions:
configuring a virtual execution environment of a host computing device to execute an application, wherein the application comprises a synchronous component and an asynchronous component, wherein the synchronous component is to be executed using a first quantity of a computing resource of the host computing device, wherein the asynchronous component is to be executed using at least a second quantity of the computing resource, wherein the second quantity is a non-zero quantity that is less than the first quantity, and wherein the second quantity is specified in application configuration data associated with the application;
provisioning the virtual execution environment with the first quantity of the computing resource, wherein the synchronous component uses at least a portion of the first quantity of the computing resource to generate a response to a request;
determining the synchronous component has generated the response and has no outstanding request awaiting response; and
reducing the computing resource provisioned to the virtual execution environment to the second quantity, wherein the asynchronous component executes using at least a portion of the second quantity of the computing resource.

14. The computer-implemented method of claim 13, further comprising determining the second quantity of the computing resource based at least partly on the application configuration data, wherein the application configuration data is provided by an application owner.

15. The computer-implemented method of claim 14, further comprising:
determining, based at least partly on the application configuration data, a container image of a plurality of container images to be used to instantiate the virtual execution environment;
obtaining the container image from a container image data store; and
instantiating die virtual execution environment using the container image.

16. The computer-implemented method of claim 13, wherein provisioning the virtual execution environment with the first quantity of the computing resource comprises provisioning the virtual execution environment with the first quantity of a virtual central processing unit (vCPU).

17. The computer-implemented method of claim 13, further comprising configuring a second virtual execution environment of the host computing device to execute a second application different from the application, wherein the second application comprises a second synchronous component and a second asynchronous component, wherein the second asynchronous component is to be executed using at least a third quantity of the computing resource, wherein the third quantity is a non-zero quantity that is different from the second quantity.

18. The computer-implemented method of claim 13, further comprising:
receiving the request from a second computing system, wherein the virtual execution environment is provisioned with the first quantity of the computing resource in response to receiving the request;
sending the request to the application; and
receiving the response from the application, wherein the determining that the synchronous component has generated the response is based on receiving the response from the application.

19. The computer-implemented method of claim 18, further comprising:
receiving a second request from a third computing system;
determining that the virtual execution environment is provisioned with the first quantity of the computing resource; and
sending the second request to the application without provisioning the virtual execution environment with an additional quantity of the computing resource.

20. The computer-implemented method of claim 13, further comprising determining that a request queue associated with the application is empty, wherein the determining that the synchronous component has no outstanding request awaiting response is based on determining that the request queue associated with the application is empty.
